(19) United States
(12) Patent Application Publication
(10) Pub. No.: US 2006/0210060 A1
(43) Pub. Date: Sep. 21, 2006

(54) Opening/closing device

(75) Inventors: Takayuki Ishikawa, Fukui (JP); Yasuchika Kudo, Fukui (JP); Koji Sakai, Fukui (JP); Masaki Nakase, Fukui (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/375,077

(22) Filed: Mar. 15, 2006

(30) Foreign Application Priority Data
Mar. 15, 2005 (JP) 2005-072540

(51) Int. Cl. H04M 1/00; E05F 1/08

(52) U.S. Cl. 379/433.13; 16/303; 16/326; 455/550.1; 455/575.3

(57) ABSTRACT

The opening and closing device involves a stationary member, a stationary cam, a rotary cam, a rotary member, a spring disposed between the stationary member and the stationary cam which pushes the stationary cam against the rotary cam, and a shaft passing through the stationary member, the stationary cam, the spring, the rotary cam and the rotary member. A head of the shaft holds the stationary member or the rotary member rotatably at its first end, and a caulked portion of the shaft fixes the shaft to the rotary member or the stationary member at its second end. Upon opening or closing operation, the stationary member or the rotary member, which is fixed to the shaft, rotates with the shaft integrally, causing no wear. The opening and closing device can realize smooth and sure operation without irregular feeling.

### FIELD OF THE INVENTION

The present invention relates to an opening/closing device for use in a variety of electronic equipment such as cell-phones, video cameras or the like.

### BACKGROUND ART

In recent years, the downsizing and the greater functionality of electronic equipment such as cell-phones, video cameras or the like are advancing rapidly. Along with the advances, many types of electronic equipment can open or close by rotating the movable housings against the stationary housings. The opening/closing device, as disclosed in Japanese Patent Unexamined Application No. 2002-206520, comes to be required to have a higher durability as well as compact size and light weight.

### SUMMARY OF THE INVENTION

The opening/closing device involves a stationary member, a stationary cam, a rotary cam, a rotary member, a spring disposed between the stationary member and the stationary cam which pushes the stationary cam against the rotary cam, and a shaft passing through the stationary member, the stationary cam, the spring, the rotary cam and the rotary member. A head of the shaft holds the stationary member or the rotary member rotatably at its first end, and a caulked portion of the shaft fixes the shaft to the rotary member or the stationary member at its second end. Upon opening/closing operation, the stationary member or the rotary member, which is fixed to the shaft, rotates with the shaft integrally, causing no wear. The opening/closing device can realize smooth and reliable operation without any sense of resistance or the like.

### BRIEF DESCRIPTION OF THE DRAWINGS

FIG. 1 shows a cross-sectional view of the opening/closing device used in an exemplary embodiment of the present invention.

FIG. 2 shows an exploded perspective view of the opening/closing device used in an exemplary embodiment of the present invention.

FIGS. 3A, 3B and 3C show partial perspective views of the opening/closing device used in an exemplary embodiment of the present invention.

FIGS. 4A, 4B and 4C show partial perspective views of the opening/closing device used in an exemplary embodiment of the present invention.

FIG. 5 shows a cross-sectional view of a comparative example of an opening/closing device.

FIG. 6 shows an exploded perspective view of a comparative example of an opening/closing device.

### DESCRIPTION OF THE INVENTION

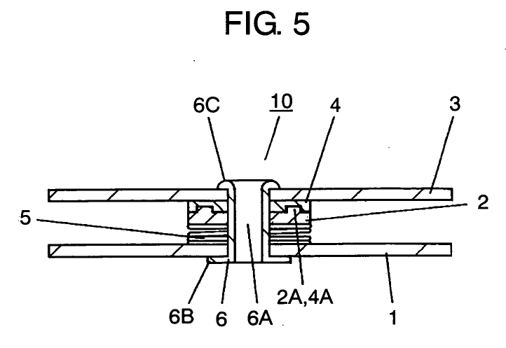

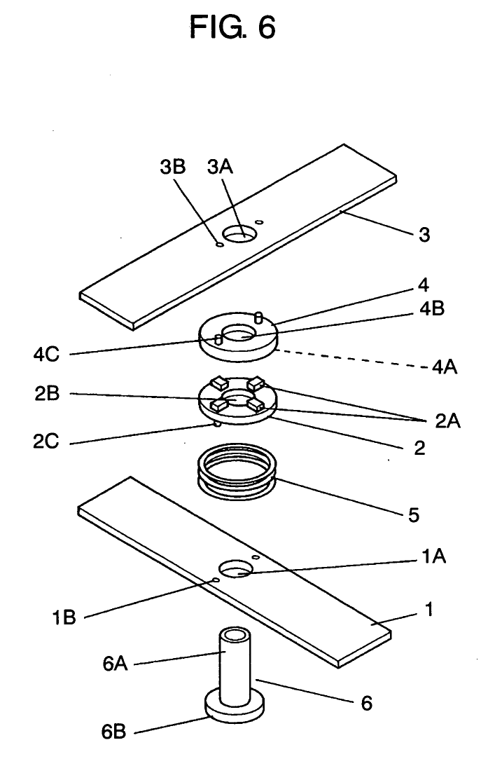

First, a comparative example of an opening and closing (opening/closing) device is described with reference to FIGS. 5 and 6. The comparative example of the opening/closing device is what the inventors of the present invention have developed for downsizing and weight saving of electronic equipment.

FIG. 5 shows a cross-sectional view of the comparative example of the opening/closing device, and FIG. 6 shows an exploded perspective view of the same. The comparative example of the opening/closing device includes generally plate-like stationary member 1 and generally disc-like stationary cam 2 with a plurality of convex cam parts 2A formed on the top surface. Through-holes 1A and 2B are formed in the center of stationary member 1 and stationary cam 2 respectively. Protrusions 2C formed on the bottom surface of stationary cam 2 are inserted into mounting-holes 1B formed outside of through-hole 1A of stationary member 1, so that stationary cam 2 is mounted on the top surface of stationary member 1.

Opening/closing device 10 further includes generally plate-like rotary member 3 and generally disc-like rotary cam 4 with a plurality of concave cam parts 4A formed on the bottom surface. Through-holes 3A and 4B are formed in the center of rotary member 3 and rotary cam 4 respectively. Protrusions 4C formed on the top surface of rotary cam 4 are inserted into mounting-holes 3B formed outside of through-hole 3A of rotary member 3, so that rotary cam 4 is mounted on the bottom surface of rotary member 3.

Opening/closing device 10 still further includes coiled spring 5. Spring 5 is disposed between the top surface of stationary member 1 and stationary cam 2 in a slightly contracted condition. Spring 5 pushes stationary cam 2 upward, pressing cam parts 2A formed on the top surface of stationary cam 2 to engage cam parts 4A formed on the bottom surface of rotary cam 4.

Opening/closing device 10 further includes a hollow cylindrical shaft 6 made of a metal. Cylindrical part 6A of shaft 6 passes through-hole 1A of stationary member 1, spring 5, through-hole 2B of stationary cam 2B, through-hole 4B of rotary cam 4 and through-hole 3A of rotary member 3. Shaft 6 has head 6B with a larger outer diameter than cylindrical part 6A in its lower end, and the top surface of head 6B abuts to the bottom surface of stationary member 1.

The upper end of cylindrical part 6A of shaft 6 is spread out for caulking by using generally conical punch or the like (not shown) as shown in FIG. 5. Spread portion 6C is formed to have a larger outer diameter than cylindrical part 6A as well as through-hole 3A. Rotary member 3 that has been caulked to shaft 6 keeps a distance against stationary member 1. Within the distance, stationary cam 2 and rotary cam 4 are held so that stationary cam 2 can move vertically, and stationary member 1 and rotary member 3 are held on shaft 6 rotatably. However, shaft 6 is not fixed to rotary member 3 in opening/closing device 10. The above is the configuration of a comparative example of opening/closing device 10.

Opening/closing device 10 with the above configuration is used in such devices as cell-phones, video cameras or the like, which have a stationary housing and a rotary housing. Stationary member 1 is fixed to the stationary housing (not shown) provided with a plurality of operating parts, a micro-phone or the like, and rotary member 3 is fixed to a rotary housing (not shown) provided with a display, a speaker, a camera or the like. Such opening/closing device 10 enables electronic equipment to open or close the rotary housing against the stationary housing.

FIG. 6 illustrates an example when cam parts 2A and 4A of opening/closing device 10 engage at the angular positions of 0, 90, 180 and 270 degree. Next, the operation of opening/closing device with such configuration is described.

A condition when rotary member 3 is laid on stationary member 1 in parallel longitudinary, or when the rotary housing is closed on stationary housing, is taken as the angular position of 0 degree.

Upon turning the rotary housing from the angular position of 0 degree to the opening direction, rotary cam 4 rotates together with rotary member 3. When rotary cam 4 rotates just 90 degrees, concave cam parts 4A provided on the bottom surface of cam 4 comes to engage with convex cam parts 2A provided on the top surface of cam 2, and rotary member 3 is once held at the opening position of just 90 degrees.

When rotary member 3 rotates further from the angular position of 90 degrees, stationary cam 2 moves down, cam parts 4A released from cam parts 2A, and rotary cam 4 rotates. After turning another 90 degrees where angular position is 180 degrees from the closed condition (0 degree), cam parts 2A pushed by spring 5 comes to engage cam parts 4A, and then rotary member 3 is stopped.

Namely, by turning rotary member 3 fixed to the rotary housing of electronic equipment, the rotary housing opens and closes against stationary housing. Depending on the relative angular position between rotary cam 4 fixed to rotary member 3 and stationary cam 2 fixed to stationary member 1, the rotary housing can be held at a predetermined angular position such as 0, 90, 180 degree or the like.

In the aforementioned comparative example of opening/closing device, however, head 6B provided on the lower end of shaft 6 only contacts to the bottom surface of stationary member 1. Also, spread portion 6C formed at the upper end of shaft 6 only contacts to rotary member 3. As shaft 6 does not function to limit the rotation of stationary member 1 or rotary member 3, wears between head 6B and the bottom surface of stationary member 1 and wears between spread portion 6C and the top surface of rotary member 3 are caused after repeating the opening/closing operation. When the wears becomes worse, the opening/closing operation becomes malfunctioned with irregular feeling.

The present invention is aiming at improving the durability and operability of the opening/closing device in the comparative example with keeping the features of downsizing and weight saving.

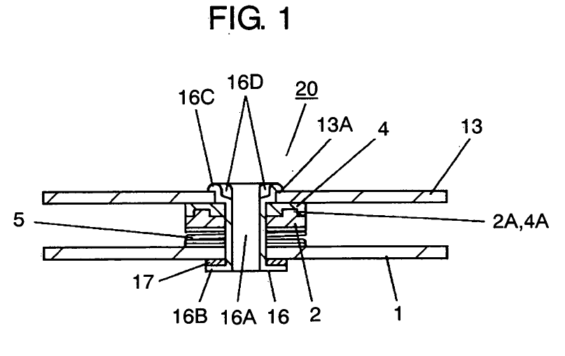

Next, the exemplary embodiments of the present invention are described with reference to FIGS. 1 to 4. Elements similar to the elements used to describe the comparative example of the opening/closing device have the same reference marks and the description is simplified.

### EXEMPLARY EMBODIMENTS

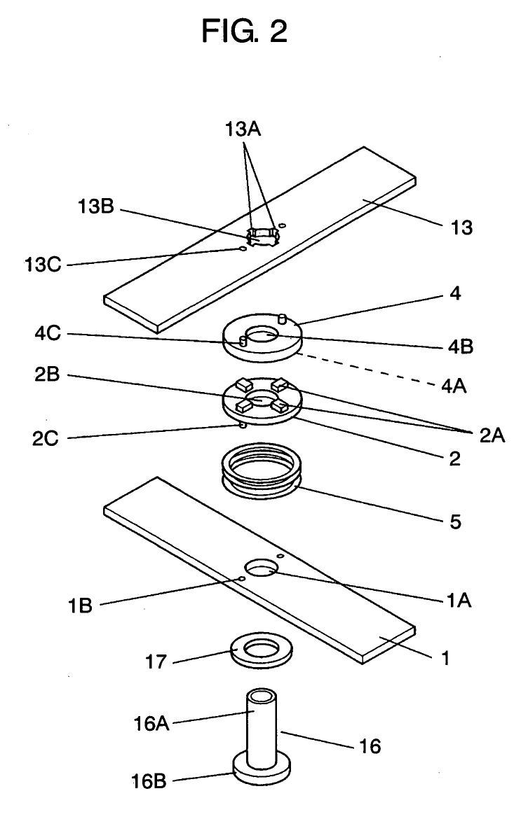

FIG. 1 shows a cross-sectional view of the opening/closing device used in exemplary embodiment 1 of the present invention and FIG. 2 shows an exploded perspective view of the same. Opening/closing device 20 used in exemplary embodiment 1 of the present invention includes: stationary member 1, or the first board, formed generally plate-shaped using a metal such as steel, copper-alloy or the like; and stationary cam 2 (first cam) formed generally disc-shaped using a metal such as steel, copper alloy or the like and provided with a plurality of convex cam parts 2A on its top surface. Through-holes 1A and 2B are formed in the center of stationary member 1 and stationary cam 2 respectively. Protrusions 2C formed on the bottom surface of stationary cam 2 are inserted into mounting-holes 1B formed outside of through-hole 1A of stationary member 1 to mount stationary cam 2 on the top surface of stationary member 1.

Opening/closing device 20 further includes rotary member 13, or the second board, formed generally plate-shaped using a metal such as steel, copper-alloy or the like. Through-hole 13B provided with at least one notch 13A dented outwardly is formed in the center of rotary member 13. Mounting-holes 13C are formed outside of through-hole 13B.

Opening/closing device 20 still further includes rotary cam 4 made of a metal such as steel, copper-alloy or the like, formed generally disc-shape. Rotary cam 4 (second cam) has a plurality of concave cam parts 4A on its bottom surface and additionally has through-hole 4B formed in the center. Protrusions 4C formed on the top surface of rotary cam 4 are inserted into mounting-holes 13C formed on stationary member 13 to mount rotary cam 4 on the bottom surface of rotary member 13.

Opening/closing device 20 further includes spring 5 made of a coiled steel wire. Spring 5 is disposed between the top surface of stationary member 1 and stationary cam 2 in a slightly contracted condition. Spring 5 performs to push stationary cam 2 upward and presses cam part 2A to cam part 4A formed on the bottom surface of rotary cam 4. Also, cam part 2A and cam part 4A eangage each other.

Opening/closing device 20 still further includes a hollow shaft 16 made of a metal such as steel, copper-alloy or the like in cylindrical shape. Cylindrical part 16A of shaft 16 passes through-hole 1A, spring 5, through-hole 2B of stationary cam 2, through-hole 4B of rotary cam 4 and through-hole 13B of rotary member 13. Shaft 16 has head 16B with a larger outer diameter than cylindrical part 16A on its lower end.

The upper end of cylindrical part 16A of shaft 16 is spread out for caulking by using generally conical punch or the like (not shown) as shown in FIG. 1. Spread portion 6C is formed to have a larger outer diameter than cylindrical part 16A as well as through-hole 13B. Rotary member 13 that has been caulked to shaft 6 keeps a distance against stationary member 1. Within the distance, stationary cam 2 and rotary cam 4 are held so that stationary cam 2 can move vertically, and stationary member 1 and rotary member 3 are held on shaft 6 rotatably.

Next, forming method of spread portion 16C is described.

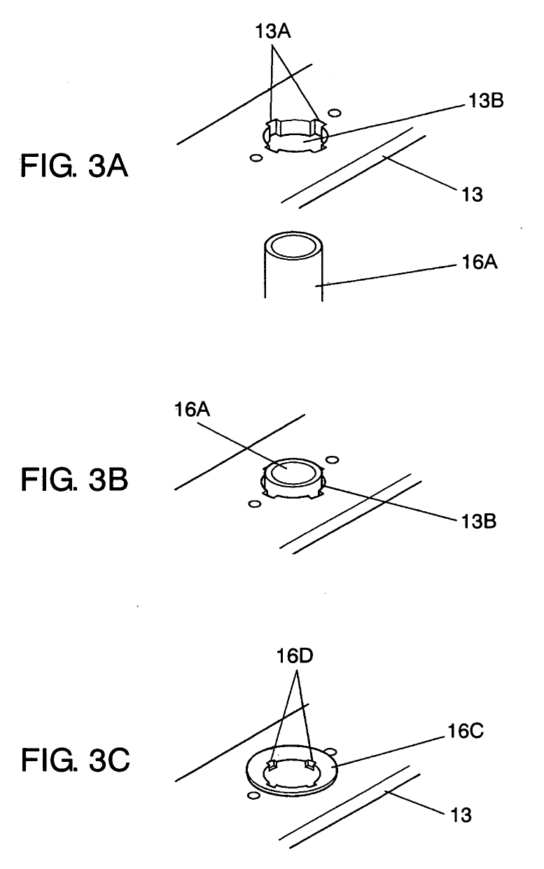

First, the upper end of cylindrical part 16A of shaft 16 is inserted into through-hole 13B from beneath rotary member 13 as shown in FIG. 3A. Next, the upper end of cylindrical part 16A is projected slightly out of the top surface of rotary member 13 as shown in FIG. 3B, and the upper end is then depressed from above rotary member 13 by using generally conical punch (not shown), to form spread portion 16C for caulking.

As shown in FIG. 3C, the upper end of cylindrical part 16A is spread out and bent down radially for caulking. As through-hole 13B is provided with at least one notch 13A dented outward, the periphery of cylindrical part 16A protrudes to the notch 13A, forming at least one fixing portion 16D on inner periphery of spread portion 16C. As a result, the upper end of cylindrical part 16A of shaft 16 is fixed by caulking on rotary member 13, thereby integrating rotary member 13 with shaft 16. That is, shaft 16 has on its first end a caulked portion, consisting of spread portion 16C and fixing portions 16D, to fix rotary member 13. Fixing positions 16D protruded into notches 13A can limit a rotation of shaft 16 against rotary member 13. Additionally, spread portion 16C spread out radially on the top surface of rotary member 13 can limit rotary member 13 to move upward.

Opening/closing device 20 further includes lubricating plate 17 disposed between head 16B located at the end of shaft 16 and the bottom surface of stationary member 1 as shown in FIG. 1. Lubricating plate 17 is a plate having a through-hole and is produced by using mixed-nylon with carbon, nickel-plated steel or the like to have a lubricating surface. Lubricating plate 17 is requested to have a through-hole and a lubricating surface, but is not limited to have a round outline.

Opening/closing device 20 with the aforementioned configuration is used for instance in cell-phones, video cameras or the like. Stationary member 1 is fixed to a stationary housing (not shown) provided with a plurality of operation parts, micro-phone or the like, and rotary member 13 is fixed to a rotary housing (not shown) provided with a display, a speaker, a camera or the like. Electronic equipment with such opening/closing device enables to open and close the rotary housing against the stationary housing.

FIG. 2 illustrates a case in which cam parts 2A and cam parts 4A of opening/closing device 20 can engage at the angular positions of 0, 90, 180 and 270 degrees respectively in the exemplary embodiment of the present invention. The operation of opening/closing device with such configuration is described next.

The condition when rotary member 13 is laid in parallel on stationary member 1 longitudinally, or when the rotary housing is closed on the stationary housing, is taken as the angular position of 0 degree. Upon turning rotary member 13 to the opening direction by turning rotary housing from the angular position of 0 degree, rotary cam 4 also rotates accordingly. After turning by 90 degrees, concave cam parts 4A provided on the bottom surface of rotary cam 4 engage convex cam parts 2A provided on the top surface of stationary cam 2 to hold rotary member 13 once being opened at the angular position of just 90 degrees.

When turning rotary member 13 further from the angular position of 90 degrees, stationary cam 2 moves downward leaving cam parts 4A released from cam parts 2A to rotate rotary cam 4 also. After turning still further 90 degrees to the angular position of 180 degrees from the closed condition (0-degree), spring 5 pushes cam parts 2A to engage cam parts 4A and then rotary member 13 will be stopped

Namely, turning rotary member 13 fixed to the rotary housing of equipment can perform to open and close the rotary housing against the stationary housing, and that the rotary housing can be held at a predetermined angular position such as 0, 90, 180 degree or the like with the movements of rotary cam 4 fixed to rotary member 13 and stationary cam 2 fixed to stationary member 1.

Setting the angular position of concave cam parts 4A or convex cam parts 2A in various degrees can change the holding angle between the rotary housing and stationary housing. For example, six pieces of concave cam parts 4A disposed with the angular spacing of 60 degrees each, against the same six pieces of convex cam parts 2A disposed with the same spacing of 60 degrees each or two pieces with the spacing of 180 degrees each can provide the rotary housing with a finer holding angle, or an opening angle.

In the exemplary embodiment 1, a plurality of fixing portions 16D are formed on inner periphery of spread portion 16C and the upper end of cylindrical part 16A of shaft 16 is fixed by caulking to integrate with rotary member 13. Namely, upon turning rotary member 13, which is fixed to shaft 16, the opening/closing operation would cause no wear between the bottom surface of spread portion 16C and the top surface of rotary member 13.

Moreover, lubricating plate 17 disposed between head 16B located at the end of shaft 16 and the bottom surface of stationary member 1 can reduce the wear between head 16B and stationary member 1. Consequently, rotary member 13 of opening/closing device 20 can perform the opening/closing operation smoothly without irregular feeling.

As described in exemplary embodiment 1, shaft 16 can be fixed to rotary member 13 by fixing the upper end of shaft 16 by caulking, which is a simple work for fixing compared with welding or the like. In addition, the opening/closing device can perform the operation smoothly and surely without irregular feeling or the like.

Additionally, lubricating plate 17 disposed between the lower end of shaft 16 and stationary member 1 can prevent wear between head 16B located at the end of shaft 16 and stationary member 1.

A method different from the description to fix the upper end of shaft 16 to rotary member 13 by caulking with reference to FIG. 3 is described in next exemplary embodiment 2.

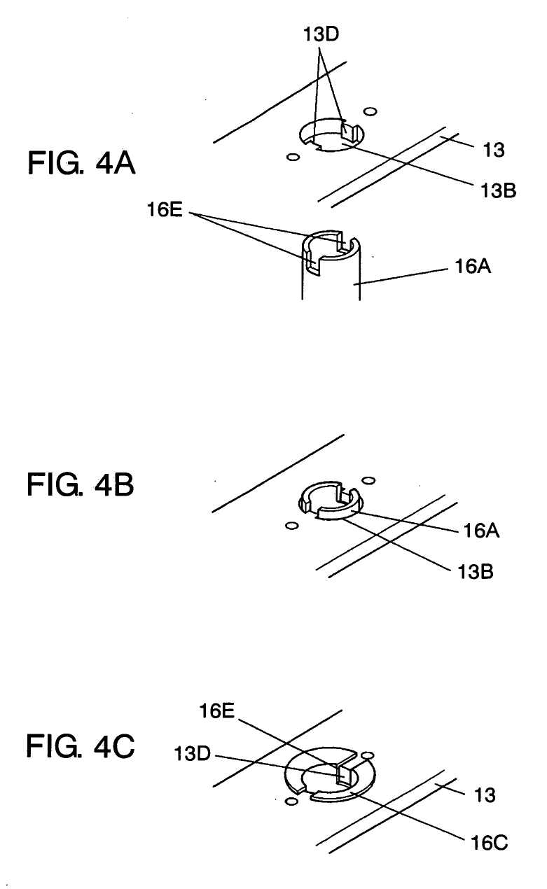

In exemplary embodiment 2, the partial perspective view in FIG. 4A shows that at least one notch 16E is provided at the upper end of cylindrical part 16A of shaft 16, and that at least one protrusion 13D is provided on through-hole 13B of rotary member 13. The example shown in this exemplary embodiment 2 has two notches 16E and two protrusions 13D.

Cylindrical part 16A is inserted into through-hole 13B from beneath rotary member 13 as shown in FIG. 4B. And then the upper end of cylindrical part 16A is then depressed from above by using, for instance, generally conical punch (not shown) or the like to spread out the upper end of cylindrical part 16A, forming spread portion 16C as shown in FIG. 4C.

In this case, protrusions 13D of rotary member 13 fit notches 16E of shaft 16, thereby fixing the upper end of cylindrical part 16A to rotary member 13 by caulking integrally. Like in exemplary embodiment 1, the fixed configuration can prevent the wear between rotary member 13 and shaft 16. In exemplary embodiment 2, shaft 16 has spread portion 16C engaging protrusions 13D to act as a caulking portion. The caulking portion (or spread portion 16C) that is spread out on the top surface of rotary member 13 also can stop rotary member 13 to move upward. In addition, the caulking portion (or spread portion 16C) that contacts appressed at edges of protrusions 13D can stop rotary member 13 to rotate around shaft 16.

In exemplary embodiment 1 and 2, it is described that the upper end of shaft 16 is fixed to shaft 16 by caulking and shaft 16 and rotary member 13 rotate together. Contrarily, a configuration in which rotary member 13 is held rotatably by shaft 16, which is fixed to stationary member 1 by caulking, is also acceptable within the scope of the embodiment of the present invention.

Moreover in exemplary embodiment 1 and 2, it is described that the configuration includes four components: stationary member 1; rotary member 13; stationary cam 2; and rotary cam 4. However, it may be acceptable that convex stationary cams are formed integrally on the top surface of stationary member 1, and concave rotary cams are formed integrally on the bottom surface of rotary member 13. In addition to this, a configuration with spring 5 disposed on the bottom surface of stationary member 1 or on the top surface of rotary member 13, to perform a resilient contact between convex stationary cams and concave rotary cams, can provide the opening/closing device with a low cost price due to a decrease in a number of parts.

It will be obvious to those skilled in the art that various changes may be made in the above-described embodiments of the present invention. However, the scope on the present invention should be determined by the following claims.

What is claimed is:

1. An opening and closing device comprising:
a stationary member;
a stationary cam fixed to the stationary member;
a rotary cam facing the stationary cam;
a rotary member fixing the rotary cam;
a spring disposed between the stationary member and the stationary cam,
wherein the spring pushes the stationary cam against the rotary cam;
and
a shaft passing through the stationary member, the spring, the stationary cam, the rotary cam and the rotary member,
wherein the shaft has a head on a first end for holding the rotary member or the stationary member rotatably and has a caulked portion on a second end for fixing the shaft to the rotary member or the stationary member.

2. The opening and closing device of claim 1 further comprising:
a lubricating plate disposed between the head of the shaft and the stationary member or the rotary member.

3. An opening and closing device comprising;
a first board having a through-hole;
a first cam having a through-hole and fixed to the first board,
wherein the first cam has a convex part on the surface opposite to the first board;
a second cam having a through-hole and facing the first cam, wherein the second cam has a concave part, which engages the convex part, on the surface facing the first cam;
a second board having a through-hole and fixing the second cam;
a spring disposed between the first board and the first cam,
wherein the spring pushes the first cam against the second cam;
and
a shaft passing through the first board, the spring, the first cam, the second cam and the second board,
wherein the shaft has a head on a first end for holding the first board or the second board rotatably and has a caulked portion on a second end for fixing the shaft to the first board or the second board.

4. The opening and closing device of claim 3, further comprising:
a lubricating plate disposed between the head of the shaft and the first board or the second board.

5. The opening and closing device of claim 3,
wherein one of the first board and the second board, which is fixed to the shaft at the caulked portion, has the through-hole provided with uneven internal periphery.

6. The opening and closing device of claim 3,
wherein one of the first board and the second board, which is fixed to the shaft at the caulked portion, has the through-hole provided with at least one notch, and the notch fix the caulked portion.

7. The opening and closing device of claim 3,
wherein one of the first board and the second board, which is fixed to the shaft at the caulked portion, has the through-hole provided with at least one protrusion, and the protrusion fix the caulked portion.
